(19) United States
(12) Patent Application Publication
(10) Pub. No.: US 2021/0400151 A1
(43) Pub. Date: Dec. 23, 2021

(54) INFORMATION PROCESSING APPARATUS, PORTABLE COMMUNICATION TERMINAL, AND NON-TRANSITORY COMPUTER-READABLE DATA RECORDING MEDIUM HAVING PROGRAM FOR CONTROLLING INFORMATION PROCESSING APPARATUS OR PORTABLE COMMUNICATION TERMINAL RECORDED THEREON

(71) Applicant: KONICA MINOLTA, INC., Tokyo (JP)

(72) Inventor: Izuru NOMURA, Toyokawa-shi (JP)

(73) Assignee: KONICA MINOLTA, INC., Tokyo (JP)

(21) Appl. No.: 17/341,248

(22) Filed: Jun. 7, 2021

(30) Foreign Application Priority Data
Jun. 23, 2020 (JP) 2020-107696

(51) Int. Cl. H04N 1/00; H04N 1/32

(52) U.S. Cl. CPC H04N 1/00079; H04N 1/32539; H04N 1/00029; H04N 1/00514

(57) ABSTRACT

A technique for switching information shown on a portable communication terminal depending on a distance from an information processing apparatus is disclosed. Processing for determining information to be shown, by a portable communication terminal used by a serviceperson who does maintenance works for an information processing apparatus, includes determining whether or not the terminal is located at a distance equal to or shorter than a prescribed distance from the information processing apparatus, reading article information from a flash memory by the terminal when the portable communication terminal is not located at the distance equal to or shorter than the prescribed distance from the information processing apparatus, reading procedural information from the flash memory when the terminal is located at the distance equal to or shorter than the prescribed distance from the information processing apparatus, and reading a check item from the flash memory after a procedure ends.

The entire disclosure of Japanese Patent Application No. 2020-107696 filed on Jun. 23, 2020 is incorporated herein by reference in its entirety.

### BACKGROUND

### Technological Field

The present disclosure relates to communication between an information processing apparatus and a communication terminal and more specifically to a technique for showing on a communication terminal, a message in accordance with a distance from an information processing apparatus.

### Description of the Related Art

Some of image forming apparatuses (which may also be referred to as multi-functional peripherals (MFPs)) and other information processing apparatuses perform a function to wirelessly communicate with a communication terminal.

For example, Japanese Laid-Open Patent Publication No. 2014-192695 discloses “an information processing apparatus etc. communicable with a communication terminal.” According to this publication, specifically, “The MFP establishes NFC wireless communication in response to a distance between a communication terminal and an NFC communication I/F becoming equal to or shorter than a prescribed distance. The MFP determines whether to communicate data with the communication terminal in any of NFC wireless communication and WFD wireless communication based on obtained data communication request information. When it is determined to use NFC wireless communication, data is communicated through NFC wireless communication. By communicating WFD connection setting information with the communication terminal through NFC wireless communication when it is determined to use WFD wireless communication, WFD wireless communication is established. Data is communicated through WFD wireless communication.” (see [Abstract]).

Japanese Laid-Open Patent Publication No. 2016-159552 discloses a technique for “allowing a user to check a state of an image forming apparatus even when the image forming apparatus is not connected to a network.” The image forming apparatus disclosed in Japanese Laid-Open Patent Publication No. 2016-159552 “includes an NFC tag board serving as short-range wireless communication means including a storage and an abnormality sensing unit that senses abnormality in image formation. When the abnormality sensing unit senses abnormality and the image forming apparatus is not connected to the network, details of abnormality are written in the storage in a manner readable from an external smartphone. A light emitter emits light to notify a user of sensing of abnormality.” (see [Abstract]).

### SUMMARY

In an environment where MFPs and other information processing apparatuses are used, from a point of view of security or the like, the MFPs themselves may be operated in an intracompany network without being connected to an external network. When an MFP fails and the MFP is found to require repair by a serviceperson, a user, a maintenance manager, or the like of the MFP should make determination himself/herself and contact a serviceperson. The serviceperson who has been called goes to a site where the MFP is installed, actually looks into the MFP, and determines what kind of failure has occurred. Depending on details of the failure, a part should be replaced. If the serviceperson is not carrying a part and that part is in a vehicle that the serviceperson has driven to the user's site, time and trouble for the serviceperson to once return to the vehicle are caused. Consequently, in some cases, time spent until completion of maintenance has been long.

Depending on a location of failure, a plurality of parts or a special tool may also be required. In such a case, the serviceperson may leave the plurality of parts or the necessary tool behind in the vehicle or bring wrong parts or tools from the vehicle by mistake.

Therefore, a technique for reducing time until completion of maintenance is required. In another aspect, a technique for preventing a part or a tool from being left behind or being mixed up is required.

An information processing apparatus in accordance with an embodiment comprises a processor, a distance measurement sensor that measures a distance from a communication terminal that communicates with the information processing apparatus, and a memory for storing a plurality of pieces of information defined in advance in accordance with the distance. The processor detects a state of the information processing apparatus, obtains a plurality of pieces of information on the state, selects information from among the plurality of pieces of information based on the distance, and transmits the selected information to the communication terminal.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing how an information processing apparatus and a portable communication terminal are wirelessly communicatively connected to each other.

FIG. 2 is a block diagram showing an exemplary configuration of an information processing apparatus 110 according to one embodiment.

FIG. 3 is a block diagram showing overview of a hardware configuration of a portable communication terminal 300 that implements portable communication terminals 120 and 130.

FIG. 4 is a block diagram showing some of functions performed by information processing apparatus 110 according to one embodiment.

FIG. 5 is a block diagrams showing some of functions performed by portable communication terminal 300 as portable communication terminals 120 and 130.

FIG. 6 is a flowchart showing a part of processing performed when a control device 210 of information processing apparatus 110 detects an error (failure) according to one embodiment.

FIG. 7 is a flowchart showing a part of processing performed by information processing apparatus 110 that has detected an error.

FIG. 8 is a flowchart showing a part of processing performed by information processing apparatus 110 for determining necessary information.

FIG. 9 is a flowchart showing a part of processing performed by portable communication terminal 130 capable of communicating with information processing apparatus 110 according to one embodiment.

FIG. 10 is a flowchart showing a part of processing performed by a processor 20 for determining information to be shown on a display 35.

FIG. 11 is a diagram conceptually showing one manner of storage of data in a server managed by a manufacturer of information processing apparatus 110.

FIG. 12 is a diagram showing one manner of communication at the time when a serviceperson does maintenance on the occurrence of failure in information processing apparatus 110.

FIG. 13 is a diagram showing one manner of communication at the time when a user does maintenance on the occurrence of failure in information processing apparatus 110.

FIG. 14 is a diagram showing one manner of communication at the time when a serviceperson does maintenance on the occurrence of failure in information processing apparatus 110.

FIG. 15 is a diagram showing information shown on display 35 of portable communication terminal 130 used by a serviceperson who does maintenance and inspection of information processing apparatus 110.

FIG. 16 is a diagram showing information shown on display 35 of portable communication terminal 120 used by a user of information processing apparatus 110.

### DETAILED DESCRIPTION OF EMBODIMENTS

Hereinafter, one or more embodiments of the present invention will be described with reference to the drawings. However, the scope of the invention is not limited to the disclosed embodiments.

An embodiment of the present invention will be described below with reference to the drawings. The same elements in the description below have the same reference characters allotted and their labels and functions are also identical. Therefore, detailed description thereof will not be repeated.

[Area where Information Processing Apparatus and Portable Communication Terminal are Used]

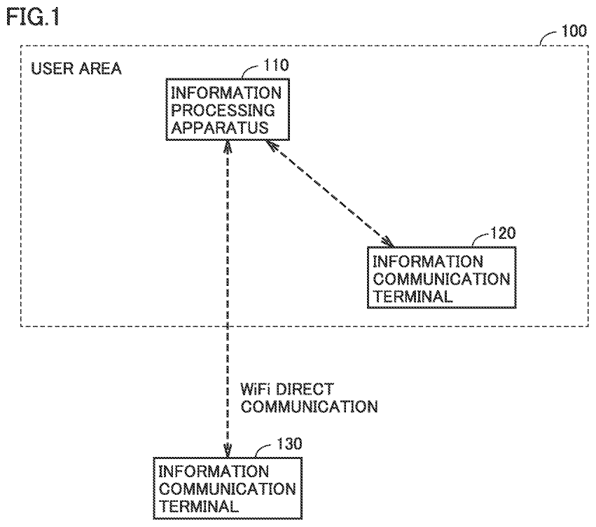

A scene in which the technique according to one embodiment is applied will be described with reference to FIG. 1. FIG. 1 is a diagram showing how an information processing apparatus and a portable communication terminal are wirelessly communicatively connected to each other.

In one aspect, an information processing apparatus 110 and a portable communication terminal 120 are used in a user area 100. Information processing apparatus 110 and portable communication terminal 120 establish wireless communication such as wireless fidelity (WiFi®) or WiFi direct® or wired communication with each other. Information processing apparatus 110 can wirelessly communicate further with portable communication terminal 130. Information processing apparatus 110 and portable communication terminal 130 wirelessly communicate with each other, for example, through a mobile communication network, WiFi direct®, and the like.

Information processing apparatus 110 includes a computer apparatus such as an image forming apparatus or a printer server apparatus. Portable communication terminals 120 and 130 are each a portable apparatus such as a smartphone or a tablet terminal. User area 100 is an area where information processing apparatus 110 is used. By way of example, user area 100 refers to one floor or one block of an office or a factory of a company, a public-interest corporation, and other business entities.

Portable communication terminal 120 is used, for example, by a user of information processing apparatus 110, that is, an employee belonging to the business entity. Portable communication terminal 130 is used by a service provider that provides services to information processing apparatus 110 or a serviceperson who actually provides services.

[Configuration of Information Processing Apparatus]

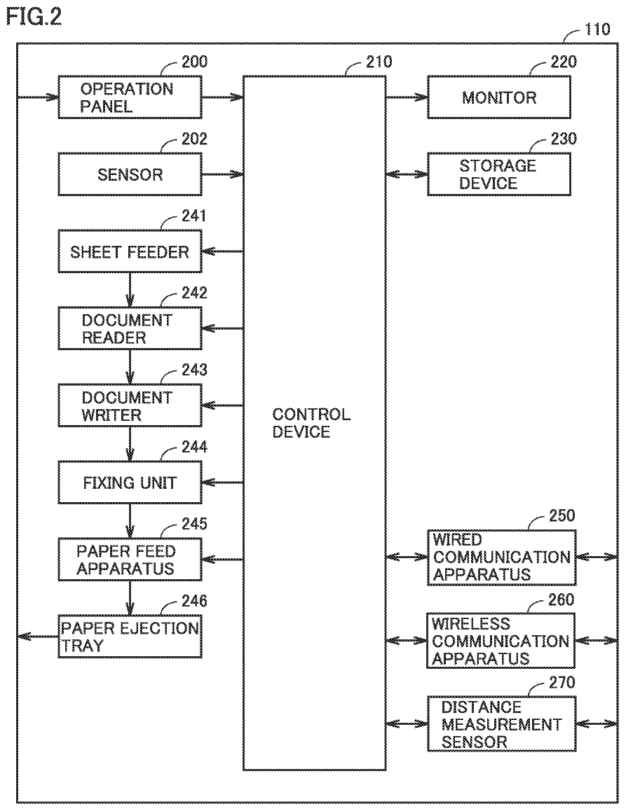

A configuration of information processing apparatus 110 will be described with reference to FIG. 2. FIG. 2 is a block diagram showing an exemplary configuration of information processing apparatus 110 according to one embodiment. Information processing apparatus 110 is implemented, for example, by an image forming apparatus. Overview of the configuration of information processing apparatus 110 will be described with reference to the image forming apparatus by way of example.

Information processing apparatus 110 includes an operation panel 200, a sensor 202, a control device 210, a monitor 220, a storage device 230, a sheet feeder 241, a document reader 242, a document writer 243, a fixing unit 244, a paper feed apparatus 245, a paper ejection tray 246, a wired communication apparatus 250, and a wireless communication apparatus 260.

Operation panel 200 accepts an input of an instruction given to information processing apparatus 110. The operation panel may include one or both of a touch panel type and a physical button type. Operation panel 200 may be removable. In this case, operation panel 200 may also be implemented by a tablet terminal.

Sensor 202 detects an internal state of information processing apparatus 110 and provides a signal in accordance with a result of detection. What is detected may include arrival of timing to replace consumable supplies, expiration of life of a replacement part, and simple failure of a part. The signal is provided to control device 210.

Control device 210 controls an operation by information processing apparatus 110. Control device 210 can be implemented by a processor capable of executing an instruction included in software, such as a central processing unit (CPU) and other processors, or combination of circuit elements that perform each type of processing and another type of hardware.

Monitor 220 shows a state of information processing apparatus 110 and other messages to the outside of information processing apparatus 110. Monitor 220 is implemented by a liquid crystal monitor, an organic electro luminescence (EL) monitor, or the like.

Storage device 230 can store both of data given to information processing apparatus 110 and data generated by information processing apparatus 110. Storage device 230 is implemented by a hard disk apparatus, a solid state drive (SSD), or another non-volatile data recording medium. Storage device 230 may be any of an embedded type and an externally connected type.

Sheet feeder 241 sends a document to document reader 242. Document reader 242 reads a document with a line sensor (not shown) or the like. Document writer 243 includes a photoconductor and a transfer roller and transfers contents of a read document to a recording medium (for example, copy paper) that passes between the photoconductor and the transfer roller.

Fixing unit 244 includes a fixation roller and a pressure roller, and fixes toner to a recording medium by melting toner attached to the recording medium by heating and further applying a pressure.

Paper feed apparatus 245 takes paper or another recording medium out of a cassette and sends it to document writer 243.

A recording medium ejected after image formation is accommodated in paper ejection tray 246.

A person skilled in the art can readily understand the configuration of the image forming apparatus. Therefore, description of the detailed configuration of the image forming apparatus will not be repeated.

Wired communication apparatus 250 communicates through Ethernet® or another cable. Wireless communication apparatus 260 communicates under WiFi®, WiFi direct®, or other standards.

[Configuration of Portable Communication Terminal]

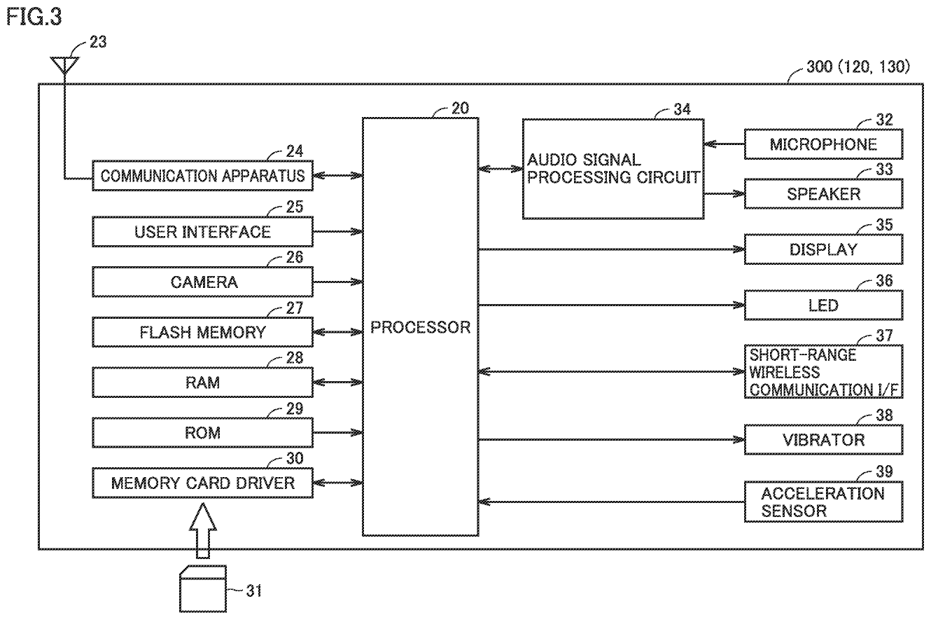

A configuration of portable communication terminals 120 and 130 will be described with reference to FIG. 3. FIG. 3 is a block diagram showing overview of a hardware configuration of portable communication terminal 300 that implements portable communication terminals 120 and 130.

In one aspect, portable communication terminal 300 is a smartphone or a tablet terminal capable of mobile communication. More specifically, portable communication terminal 300 includes a CPU 20, an antenna 23, a communication apparatus 24, an operation switch 25, a camera 26, a flash memory 27, a random access memory (RAM) 28, a read only memory (ROM) 29, a memory card driver 30, a microphone 32, a speaker 33, an audio signal processing circuit 34, a display 35, a light emitting diode (LED) 36, a short-range wireless communication I/F 37, a vibrator 38, and an acceleration sensor 39. A memory card 31 can be attached to memory card driver 30.

Antenna 23 receives a signal emitted from a base station or transmits a signal for communication with another communication apparatus through the base station. A signal received by antenna 23 is subjected to front end processing by communication apparatus 24 and the processed signal is sent to CPU 20.

Operation switch 25 accepts an operation onto portable communication terminal 300. Operation switch 25 is implemented, for example, as a hardware key or a software key. When operation switch 25 accepts an operation, it sends a signal in accordance with an operation mode of portable communication terminal 300 at that time to CPU 20.

CPU 20 performs processing for controlling an operation by portable communication terminal 300 based on an instruction given to portable communication terminal 300. When portable communication terminal 300 receives a signal, CPU 20 performs predefined processing based on the signal sent from communication apparatus 24 and sends the processed signal to audio signal processing circuit 34. Audio signal processing circuit 34 performs predefined signal processing on the signal and sends the processed signal to speaker 33. Speaker 33 provides an audio output based on the signal.

Microphone 32 accepts utterance to portable communication terminal 300 and sends a signal corresponding to uttered sound to audio signal processing circuit 34. Audio signal processing circuit 34 performs predefined processing for conversation based on the signal and sends the processed signal to CPU 20. CPU 20 converts the signal into transmission data and sends resultant data to communication apparatus 24. Communication apparatus 24 generates a transmission signal from the data and sends the signal to antenna 23.

Data sent from CPU 20 is stored in flash memory 27. CPU 20 reads data stored in flash memory 27 and performs predefined processing with that data.

RAM 28 temporarily holds data generated by CPU 20 based on an operation onto operation switch 25. ROM 29 stores a program or data for causing portable communication terminal 300 to perform a predetermined operation. CPU 20 reads the program or the data from ROM 29 and controls an operation by portable communication terminal 300.

Memory card driver 30 reads data stored in memory card 31 and sends the data to CPU 20. Memory card driver 30 writes data provided by CPU 20 into an empty area in memory card 31.

Audio signal processing circuit 34 performs signal processing for conversation as described above. In the example shown in FIG. 3, CPU 20 and audio signal processing circuit 34 are shown as components separate from each other. In another aspect, CPU 20 and audio signal processing circuit 34 may integrally be implemented.

Though display 35 is a touch panel type display, a mechanism of the touch panel is not particularly limited. Display 35 shows an image defined by data obtained from CPU 20. For example, the display shows a still image, moving images, or an attribute of a music file (a name of the file, a player, or a time period of play) stored in flash memory 27. The still image includes a rendered image and an image prepared by a manufacturer of portable communication terminal 30 by default.

LED 36 performs a predetermined light emission operation based on a signal from CPU 20.

Short-range wireless communication I/F 37 emits a signal provided from CPU 20 for wireless communication. Short-range wireless communication I/F 37 is implemented, for example, by a communication circuit that implements WiFi direct® or another type of communication between apparatuses such as what is called peer-to-peer communication.

Vibrator 38 performs a vibration operation at a predetermined frequency based on a signal provided from CPU 20.

Acceleration sensor 39 detects a direction of an acceleration applied to portable communication terminal 300. A result of detection is provided to CPU 20.

[Functional Configuration of Information Processing Apparatus]

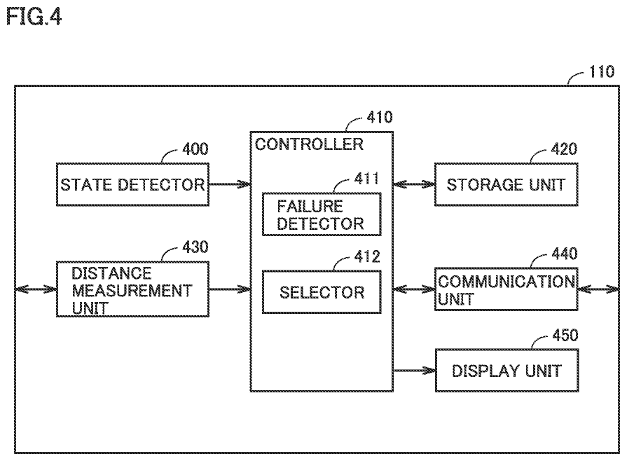

A configuration of information processing apparatus 110 will further be described with reference to FIG. 4. FIG. 4 is a block diagram showing some of functions performed by information processing apparatus 110 according to one embodiment. Information processing apparatus 110 includes a state detector 400, a controller 410, a storage unit 420, a distance measurement unit 430, a communication unit 440, and a display unit 450. Controller 410 includes a failure detector 411 and a selector 412.

State detector 400 detects a state of information processing apparatus 110. The state to be detected may include a normal state, an abnormal state, arrival of timing to supply consumable articles, and expiration of life of a replacement part. When information processing apparatus 110 is implemented by an image forming apparatus, toner represents an exemplary consumable article. A waste toner bottle or a drum represents an exemplary replacement part.

Controller 410 controls an operation by information processing apparatus 110 in accordance with an instruction given to information processing apparatus 110 or a result of detection by state detector 400. In one aspect, controller 410 as failure detector 411 can detect failure of information processing apparatus 110 based on a result indicated in a sensor signal sent from state detector 400. Failure to be sensed may include minor failure such as paper jamming or being out of toner and serious failure such as abnormal wear of a drum or break. In another aspect, controller 410 as selector 412 can select information to be transmitted to portable communication terminals 120 and 130 through communication unit 440, from among data stored in storage unit 420.

Storage unit 420 holds a program and data prepared by a manufacturer of information processing apparatus 110 for information processing apparatus 110 to perform a prescribed operation, data generated in information processing apparatus 110, data given to information processing apparatus 110, and the like.

Distance measurement unit 430 measures a distance to a user who approaches information processing apparatus 110. In one aspect, distance measurement unit 430 calculates a distance from information processing apparatus 110 to portable communication terminal 120 or portable communication terminal 130. In one aspect, distance measurement unit 430 is implemented by a time-of-flight (ToF) distance measurement sensor included in a camera module.

Communication unit 440 wirelessly communicates with portable communication terminals 120 and 130. Display unit 450 shows information on information processing apparatus 110 or service maintenance information including a procedure for replacing a part based on a signal sent from controller 410.

In one aspect, when information processing apparatus 110 is normal, controller 410 performs image formation processing, scanning processing, file transmission processing, and the like in response to a given instruction. When information processing apparatus 110 is abnormal, controller 410 performs processing for rectifying abnormality in accordance with a result of detection by state detector 400. For example, when paper jamming occurs in information processing apparatus 110, controller 410 as failure detector 411 senses paper jamming based on a signal from a sensor (not shown) provided in the vicinity of a conveyance roller (not shown). In another aspect, controller 410 can sense arrival of timing to replace a part used in information processing apparatus 110. For example, controller 410 controls storage unit 420 to store a frequency of use or operating hours of a part designated in advance as requiring maintenance and inspection. When controller 410 senses the frequency of use or the operating hours reaching the frequency or the hours defined in advance as timing of replacement, it controls display unit 450 to show arrival of timing of replacement of the part.

In one aspect, when controller 410 senses approach to information processing apparatus 110 by portable communication terminal 120 or presence of portable communication terminal 120 within a range set in advance from information processing apparatus 110, it transmits information necessary for maintenance of information processing apparatus 110 to portable communication terminal 120. The portable communication terminal can show information necessary for maintenance. Examples of information necessary for maintenance include information indicating a procedure of replacement of a part replaceable by a user himself/herself (a person in charge of maintenance in a company where information processing apparatus 110 is used) among a toner cartridge and other consumable supplies. Since the user can replace consumable supplies while the user refers to such information shown on portable communication terminal 120, even an unexperienced person can properly do a replacement work. Occurrence of a trouble at the time of replacement can thus be suppressed.

In another aspect, when controller 410 detects approach to information processing apparatus 110 by portable communication terminal 130 used by a serviceperson who is out of the office, it can transmit a current condition of information processing apparatus 110 to portable communication terminal 130. As the current condition is shown on portable communication terminal 130, the serviceperson can know the current condition of information processing apparatus 110 and hence the serviceperson can quickly start maintenance works when he/she arrives at the site.

[Functional Configuration of Portable Communication Terminal]

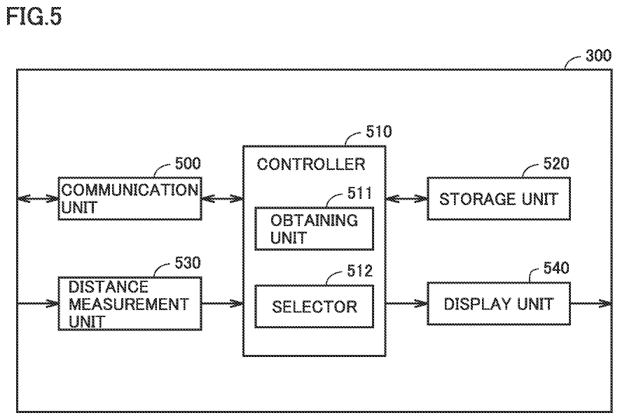

The configuration of portable communication terminals 120 and 130 will further be described with reference to FIG. 5. FIG. 5 is a block diagrams showing some of functions performed by portable communication terminal 300 as portable communication terminals 120 and 130. Portable communication terminal 300 includes a communication unit 500, a controller 510, a storage unit 520, a distance measurement unit 530, and a display unit 540. Controller 510 includes an obtaining unit 511 and a selector 512.

Communication unit 500 communicates with information processing apparatus 110. Communication unit 500 can communicate with information processing apparatus 110, for example, under WiFi direct®. The wireless communication standard is not limited to WiFi direct®, and at least any standard under which direct communication with information processing apparatus 110 can be established may be applicable.

Controller 510 controls an operation by portable communication terminal 300. Controller 510 is implemented, for example, by a CPU or another processor. In one aspect, controller 510 as obtaining unit 511 obtains information on information processing apparatus 110. Examples of obtained information may include information indicating failure of information processing apparatus 110, notification about replacement of a part, or another state, identification information for identifying a part and a tool necessary for addressing each failure, identification information for identifying a consumable article, a procedure in part replacement works, and a check item after replacement.

In another aspect, controller 510 as selector 512 selects information to be shown on display unit 540 from information stored in storage unit 520. For example, when portable communication terminal 120 used by a general user receives a notification of failure of information processing apparatus 110, selector 512 may select information depending on a type of that failure.

For example, in one aspect, when the general user is unable to address the failure or when the general user has not been given authority to do maintenance for addressing the failure, selector 512 selects information for calling a serviceperson and has display unit 540 show the information.

In another aspect, when the general user is able to address the failure or when the general user has been given authority to do maintenance for addressing the failure, selector 512 has display unit 540 show identification information for identifying a part to be replaced, a procedure for replacement works, or a check item after replacement, for inviting the user of portable communication terminal 120 to address the failure.

Storage unit 520 holds a program and control data prepared by a manufacturer of portable communication terminal 300 or a manufacturer of information processing apparatus 110. Storage unit 520 is implemented by a non-volatile data recording medium such as a ROM or a flash memory. In another aspect, storage unit 520 may hold data received by portable communication terminal 300 from information processing apparatus 110 or data entered by the user of portable communication terminal 300.

Distance measurement unit 530 measures a distance between information processing apparatus 110 and portable communication terminal 300. In one aspect, distance measurement unit 530 is implemented by a ToF distance measurement sensor included in a camera module.

Display unit 540 shows information received by portable communication terminal 300 and information stored in storage unit 520. In one aspect, display unit 540 is implemented by a liquid crystal monitor, an organic EL monitor, or the like. In another aspect, display unit 540 may accept a touch operation.

[Control Structure]

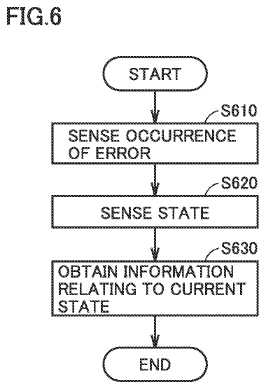

A control structure of information processing apparatus 110 will be described with reference to FIGS. 6 to 8. FIG. 6 is a flowchart showing a part of processing performed when control device 210 of information processing apparatus 110 senses an error (failure) according to one embodiment.

In step S610, control device 210 senses occurrence of an error (failure) in information processing apparatus 110 based on a signal from a sensor (not shown).

In step S620, control device 210 senses a state of information processing apparatus 110 based on a signal from the sensor.

In step S630, control device 210 obtains information relating to the current state. More specifically, for example, control device 210 reads from storage device 230, service maintenance information defined in advance depending on an error.

[Processing at the Time of Sensing of Error]

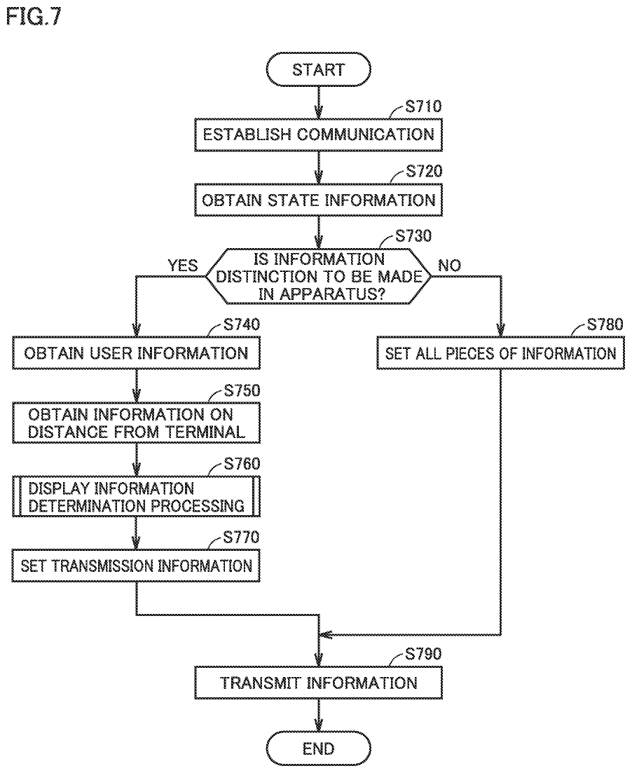

FIG. 7 is a flowchart showing a part of processing performed by information processing apparatus 110 that has sensed an error.

In step S710, control device 210 establishes communication with portable communication terminal 120, 130. For example, when control device 210 senses occurrence of an error (or failure) in information processing apparatus 110, it communicates with portable communication terminal 120, 130.

In step S720, control device 210 obtains information representing a state of information processing apparatus 110 (which is also referred to as “state information”) from storage device 230. The state information may include, for example, a site where abnormality has been sensed in information processing apparatus 110 and an error code defined in advance for abnormality.

In step S730, control device 210 determines whether or not to make information distinction in information processing apparatus 110. This determination is made based on definition prepared as a policy which addresses abnormality that may occur in information processing apparatus 110. By way of example of definition, for example, replacement of a toner cartridge is defined to be done by a user (or by a maintenance service provider). In this case, control device 210 determines that information processing apparatus 110 is to make information distinction. Replacement of a photoconductor drum or another internal part is defined to be done by a maintenance service provider designated by a manufacturer of information processing apparatus 110. In this case, control device 210 determines that information processing apparatus 110 is not to make information distinction.

When control device 210 determines that information processing apparatus 110 is to make information distinction (YES in step S730), it notifies portable communication terminals 120 and 130 that it will communicate with user's portable communication terminal 120. Thereafter, control device 210 switches control to step S740.

The maintenance service provider can thus at least know that an error has occurred in information processing apparatus 110 and that the error will be addressed by the user, based on the information received by portable communication terminal 130. Portable communication terminal 130 further updates a database of information on maintenance and inspection of information processing apparatus 110 based on received information.

When control device 210 determines that information processing apparatus 110 is not to make information distinction (NO in step S730), it notifies portable communication terminals 120 and 130 that contact with the maintenance service provider is to be made. The user of portable communication terminal 120 can know that the error in information processing apparatus 110 will be addressed by the maintenance service provider. The maintenance service provider can recognize necessity to address information processing apparatus 110 based on information received by portable communication terminal 130. Thereafter, control device 210 switches control to step S780.

In step S740, control device 210 obtains user information. More specifically, control device 210 reads information on an administrator or the like of information processing apparatus 110 from storage device 230.

In step S750, control device 210 obtains a distance from portable communication terminal 120 based on a result of sensing by distance measurement sensor 270.

In step S760, control device 210 performs display information determination processing which will be described later. As this processing is performed, information shown on display 35 of portable communication terminal 120 that can communicate with information processing apparatus 110 is determined. In another aspect, this information may be shown on monitor 220 of information processing apparatus 110 or may be transmitted to portable communication terminal 130 and shown on display 35 of portable communication terminal 130.

In step S770, control device 210 sets information to be transmitted to portable communication terminal 120. More specifically, control device 210 collects and summarizes information to be transmitted to portable communication terminal 120.

In step S780, control device 210 sets all pieces of information. More specifically, control device 210 generates as transmission information, information necessary for the serviceperson who uses portable communication terminal 130 to do maintenance of information processing apparatus 110. The serviceperson can quickly know information necessary for maintenance of information processing apparatus 110 by receiving such information.

In step S790, control device 210 transmits information to portable communication terminal 130. In another aspect, control device 210 may transmit the information to portable communication terminal 120 or may have the information shown on monitor 220.

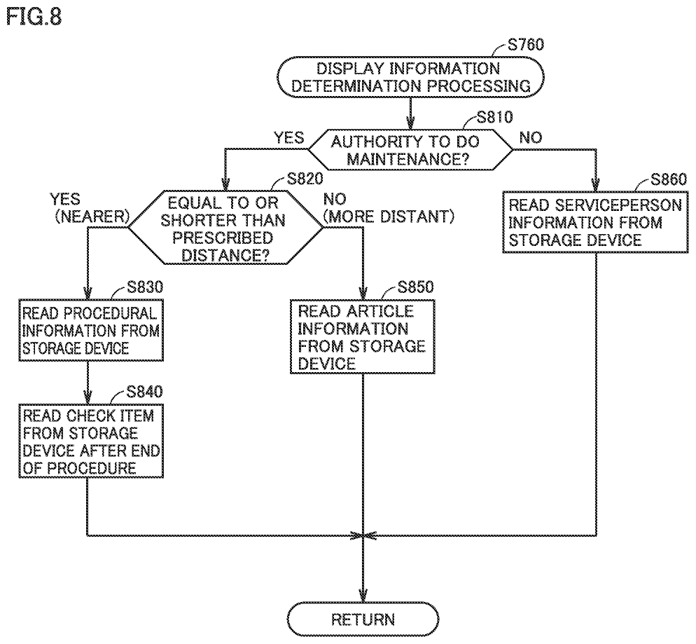

FIG. 8 is a flowchart showing a part of processing performed by information processing apparatus 110 for determining necessary information.

In step S810, control device 210 determines whether or not the user (for example, a person in charge of maintenance or a system administrator) of information processing apparatus 110 has been given authority for maintenance necessary for addressing the sensed error. When the control device determines that the user has been given authority for maintenance (YES in step S810), it switches control to step S820. Otherwise (NO in step S810), control device 210 switches control to step S860.

In step S820, control device 210 determines whether or not a distance between information processing apparatus 110 and the user (the person in charge of maintenance or the system administrator) is equal to or shorter than a predetermined distance. This determination is made, for example, based on whether or not the user is present in the vicinity of information processing apparatus 110 based on an output from distance measurement sensor 270. When control device 210 determines that portable communication terminal 120 is near, that is, the distance to the user is shorter than the predetermined distance (YES in step S820), it switches control to step S830. Otherwise (that is, portable communication terminal 120 is distant) (NO in step S820), control device 210 switches control to step S850.

In step S830, control device 210 reads from storage device 230, procedural information defined in advance for addressing the error. Control device 210 has the read procedural information shown on monitor 220. The user can perform the procedure for eliminating the error in information processing apparatus 110 by referring to the procedural information. For example, when replacement of a toner cartridge is detected as the error with an MFP being provided as information processing apparatus 110, the user can detach an old toner cartridge and attach a new toner cartridge in accordance with the procedure shown on monitor 220.

In step S840, control device 210 reads from storage device 230, information on an item to be checked after addressing the error and has monitor 220 show the item. By checking the shown item, the user can check whether or not maintenance was appropriately done even when the user himself/herself does the maintenance works. This information is emitted to portable communication terminal 120 by information processing apparatus 110 as transmission information (step S770).

In step S850, control device 210 reads article information from storage device 230. The article information includes information for identifying a part necessary for maintenance. The article information can also be emitted as transmission information to portable communication terminal 120 by information processing apparatus 110 (step S770).

In step S860, control device 210 reads serviceperson information from storage device 230. The serviceperson information may include identification information and a serial number of information processing apparatus 110 where an error has occurred, identification information and contact information of a serviceperson registered as a maintenance and inspection service provider for information processing apparatus 110. The contact information includes a telephone number and an electronic mail address.

Thereafter, as described above, control device 210 sets transmission information (step S770) and sends the transmission information to portable communication terminal 130 (step S790).

[Control Structure of Portable Communication Terminal]

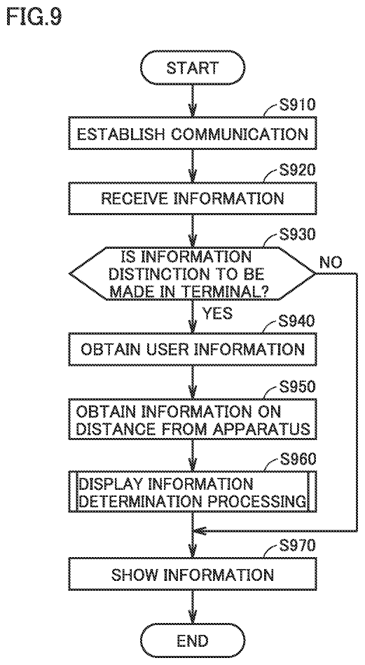

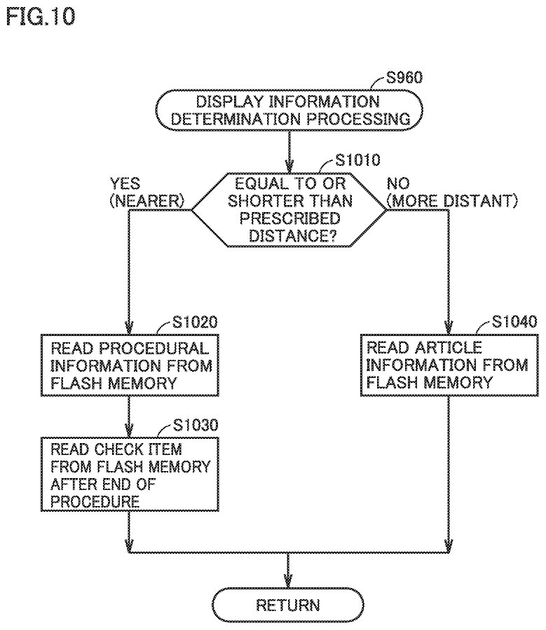

A control structure of the portable communication terminal will be described with reference to FIGS. 9 and 10. FIG. 9 is a flowchart showing a part of processing performed by portable communication terminal 130 capable of communicating with information processing apparatus 110 according to one embodiment. FIG. 10 is a flowchart showing a part of processing performed by processor 20 for determining information to be shown on display 35.

As shown in FIG. 9, in step S910, processor 20 establishes communication with information processing apparatus 110. For example, in one aspect, when information processing apparatus 110 that has sensed an error transmits predetermined information for giving a notification of the error to portable communication terminal 130, communication is established. In another aspect, when an administrator of information processing apparatus 110 that has sensed an error indicates issuance of a notification to portable communication terminal 130 registered as a contact destination, communication is established. In the present embodiment, establishment of communication does not mean that information processing apparatus 110 and portable communication terminal 130 are constantly in connection to each other, but communication is established so long as at least portable communication terminal 130 is notified of the error that has occurred in information processing apparatus 110 and a serviceperson who is the user of portable communication terminal 130 replies to information processing apparatus 110 that he/she has acknowledged the notification. When information processing apparatus 110 receives the reply from portable communication terminal 130 to the effect that the notification has been acknowledged, it prepares detailed information to be transmitted to portable communication terminal 130 and thereafter transmits the detailed information. The detailed information includes identification information for identifying information processing apparatus 110, identification information for identifying an error, information for specifying a location where information processing apparatus 110 is installed, and the like.

In step S920, processor 20 receives information transmitted from information processing apparatus 110. For example, it receives the detailed information above.

In step S930, processor 20 determines whether or not to make information distinction in portable communication terminal 130. In the present embodiment, information distinction includes analysis of an error that has occurred in information processing apparatus 110 and determination of an entity who addresses the error. For example, whether or not a user is able to address the error or whether or not a serviceperson should address the error is determined depending on details of the error. Alternatively, information distinction is made based on maintenance rules or the like predetermined as an entity that makes determination when an error occurs. When processor 20 determines that information distinction is to be made in portable communication terminal 130 (YES in step S930), it switches control to step S940. Otherwise (NO in step S930), processor 20 switches control to step S970.

In step S940, processor 20 obtains user information associated with information processing apparatus 110 from flash memory 27, based on identification information for identifying information processing apparatus 110. The user information includes a name and a telephone number of an administrator in a business entity where information processing apparatus 110 is used.

In step S950, processor 20 obtains distance information on a distance to information processing apparatus 110. The distance information may be calculated, for example, based on positional information of information processing apparatus 110 and positional information of portable communication terminal 130. In another aspect, the distance information may be calculated based on intensity of a signal received from information processing apparatus 110. By way of example, the distance information may be calculated based on an output from short-range wireless communication I/F 37. Short-range wireless communication I/F 37 is, for example, an interface circuit for WiFi direct® communication.

In step S960, processor 20 performs display information determination processing which will be described later. As this processing is performed, information shown on display 35 is determined.

In step S970, processor 20 has information shown on display 35. Example of the shown information include identification information for identifying information processing apparatus 110, an installation location or other information associated with information processing apparatus 110, identification information for identifying an error, and a procedure, a part, and a tool necessary for addressing the error. The serviceperson who is the user of portable communication terminal 130 goes to a place where information processing apparatus 110 is installed while he/she refers to such information. Since information necessary for addressing the error that has occurred in information processing apparatus 110 is shown in advance on portable communication terminal 130 (before the serviceperson arrives at information processing apparatus 110), the serviceperson can be ready for addressing the error without omission.

Referring to FIG. 10, in step S1010, processor 20 determines whether or not a distance between portable communication terminal 130 and information processing apparatus 110 is equal to or shorter than a predetermined distance. When processor 20 determines that the distance is equal to or shorter than the prescribed distance (YES in step S1010), it switches control to step S1020. Otherwise (NO in step S1010), processor 20 switches control to step S1040.

In step S1020, processor 20 reads the procedural information from flash memory 27. For example, processor 20 reads from flash memory 27, information indicating a procedure determined in advance as a procedure necessary for addressing the error, based on identification information for identifying information processing apparatus 110 and an identification code for identifying the detected error. As the serviceperson arrives at information processing apparatus 110, he/she can perform the procedure necessary for recovery by referring to the procedural information. As the serviceperson completes the necessary procedure, he/she enters completion of the procedure into portable communication terminal 130.

In step S1030, in response to completion of the necessary procedure, processor 20 reads a check item from flash memory 27 and has display 35 show the check item. The serviceperson can confirm that the procedure for eliminating the error in information processing apparatus 110 was performed as following the prescribed procedure, by referring to the check item. Thereafter, processor 20 returns control to main processing.

In step S1040, processor 20 reads article information from flash memory 27. Examples of the article information include a replacement part or a supplementary part necessary for addressing the error. Processor 20 retrieves the article information based on identification information for identifying information processing apparatus 110 and identification information for identifying the error included in received information. Thereafter, processor 20 returns control to main processing.

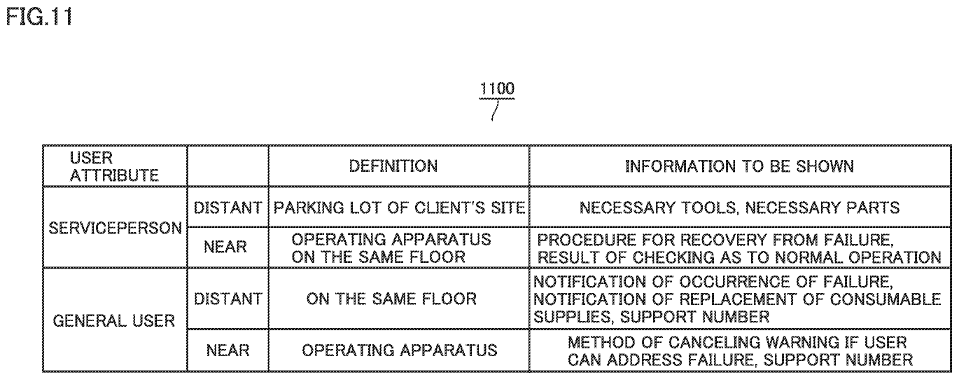

Information shown on portable communication terminals 120 and 130 will be described with reference to FIG. 11. FIG. 11 is a diagram conceptually showing one manner of storage of data in a server managed by a manufacturer of information processing apparatus 110. In one aspect, the server holds a table 1100. Table 1100 defines information to be shown on portable communication terminals 120 and 130 for each of the serviceperson and the user. This shown information is defined depending on length of the distance to information processing apparatus 110.

For example, when the serviceperson is distant from information processing apparatus 110 (“distant”), a necessary instrument and a necessary part are defined as information shown on portable communication terminal 130. Distant here means, for example, that the serviceperson is distant to such an extent as being present in a parking lot of a site of a client (a business entity representing a user). In another aspect, portable communication terminal 130 being distant from information processing apparatus 110 to such an extent as being unable to communicate under WiFi direct® may be regarded as being distant. When the serviceperson is near information processing apparatus 110, a procedure for recovery from failure or a result of checking as to whether or not the apparatus normally operates is shown on portable communication terminal 130. Near means, for example, such proximity as the serviceperson being able to touch information processing apparatus 110 or being present on a floor where information processing apparatus 110 is installed. In one aspect, an example in which portable communication terminal 130 can communicate with information processing apparatus 110 under WiFi direct® may be regarded as being near.

When the user (maintenance manager) is distant, notification of occurrence of failure, notification of replacement of consumable supplies, a support number, and the like may be shown on portable communication terminal 120. In this case, distant means that the user and information processing apparatus 110 are distant from each other to such an extent as being present on the same floor. The support number refers to a number for specifying measures defined for addressing an error that occurs in information processing apparatus 110. When the user is near information processing apparatus 110 and if the user is able to address an error depending on a type of the error, a method of canceling a warning, the support number, and the like may be shown on portable communication terminal 120. Near means that the user is in the vicinity to such an extent as being able to operate information processing apparatus 110.

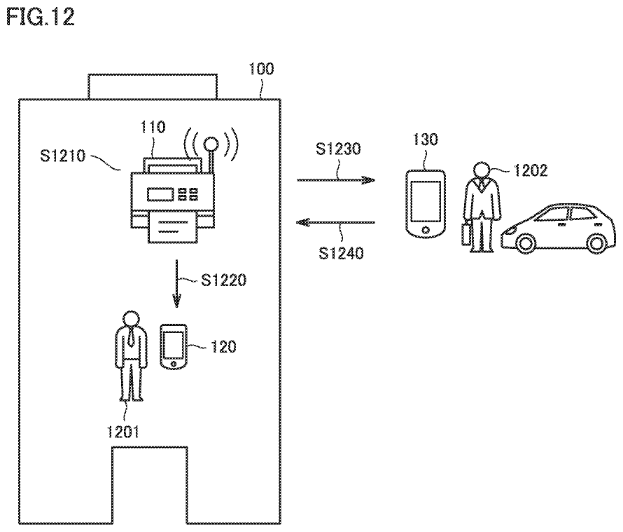

Communication between information processing apparatus 110 and portable communication terminals 120 and 130 in accordance with the present embodiment will be described with reference to FIGS. 12 to 14.

FIG. 12 is a diagram showing one manner of communication at the time when a serviceperson does maintenance on the occurrence of failure in information processing apparatus 110.

In step S1210, information processing apparatus 110 senses occurrence of failure based on an output from sensor 202. For example, control device 210 senses necessity of replacement of the transfer roller.

In step S1220, information processing apparatus 110 generates information for notification of occurrence of failure and notifies the user (administrator) of information processing apparatus 110 of occurrence of failure. For example, control device 210 transmits a message indicating occurrence of failure to portable communication terminal 120 registered in advance as a contact destination. When the user of portable communication terminal 120 acknowledges the message, he/she contacts the service center of information processing apparatus 110 to ask the service center to address the failure. The contact may be made by any of a mail and a telephone call. The entity who makes a contact is not limited to the user, and information processing apparatus 110 may transmit a message. When a serviceperson receives such a message, he/she goes to the user's site while carrying parts necessary for maintenance of information processing apparatus 110. When the serviceperson arrives at the user's site, he/she notifies the user of that fact, or operates portable communication terminal 130 to notify portable communication terminal 120 or information processing apparatus 110 of arrival.

In step S1230, when information processing apparatus 110 senses arrival of the serviceperson, it transmits information on a necessary article to portable communication terminal 130 of the serviceperson. In another aspect, information processing apparatus 110 may transmit the article information to portable communication terminal 130 based on an instruction from the user. When portable communication terminal 130 receives information from information processing apparatus 110, it shows the article information on display 35. Referring to the shown article information, the serviceperson goes to the floor where information processing apparatus 110 is located, while carrying parts and tools necessary for maintenance of information processing apparatus 110.

In step S1240, the serviceperson replaces the transfer roller and completes maintenance of information processing apparatus 110. Since portable communication terminal 130 shows the procedure on display 35, even the serviceperson less experienced in maintenance of information processing apparatus 110 can reliably do maintenance of information processing apparatus 110 by referring to the procedure.

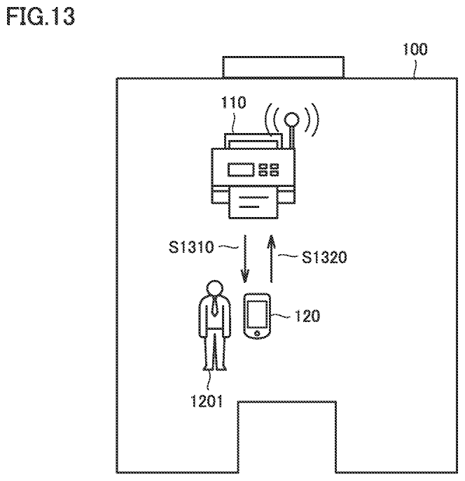

FIG. 13 is a diagram showing one manner of communication at the time when a user does maintenance on the occurrence of failure in information processing apparatus 110.

In step S1310, information processing apparatus 110 senses occurrence of an error based on an output from sensor 202. For example, control device 210 senses necessity of replacement of a waste toner bottle. Information processing apparatus 110 transmits sensed contents to portable communication terminal 120. The contents are transmitted, for example, by a mail or a text message. Examples of transmitted information include identification information for identifying information processing apparatus 110, identification information for identifying an error, and specific details of the error such as replacement of the waste toner bottle in the example above. Portable communication terminal 120 determines whether or not the user is able to address the present error based on information received from information processing apparatus 110 and a manual defined in advance. The manual defines, for example, that the user is able to replace the waste toner bottle.

In step S1320, when portable communication terminal 120 is at a distance, that is, “distant” from information processing apparatus 110, portable communication terminal 120 may show the article information as information necessary for addressing the error. For example, in order to avoid the user going to information processing apparatus 110 without carrying parts necessary for replacement, portable communication terminal 120 notifies the user that there are parts that should be carried with him/her. For example, when portable communication terminal 120 determines that the user is able to address the sensed error, it reads information necessary for addressing the error from flash memory 27 and shows that information on display 35. In this case, the information includes identification information for identifying information processing apparatus 110 that requires replacement of the waste toner bottle and a product number of the waste toner bottle necessary for replacement.

When the user goes to information processing apparatus 110 with a replacement part (waste toner bottle) and comes close to such an extent as being able to operate information processing apparatus 110, portable communication terminal 120 determines the user as being located near information processing apparatus 110 and shows a work procedure necessary for replacing the waste toner bottle on display 35. The user can replace the waste toner bottle by referring to the work procedure.

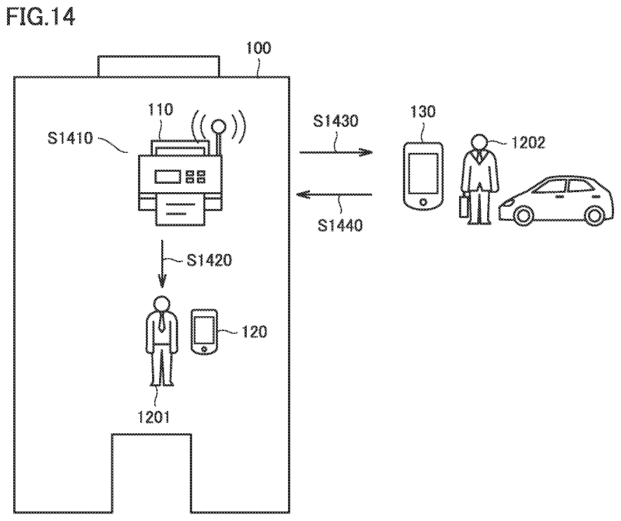

FIG. 14 is a diagram showing one manner of communication at the time when a serviceperson does maintenance on the occurrence of failure in information processing apparatus 110.

In step S1410, information processing apparatus 110 senses occurrence of failure based on an output from sensor 202. For example, control device 210 senses necessity of replacement of a paper feed roller.

In step S1420, information processing apparatus 110 generates information giving a notification of occurrence of failure to notify the user (administrator) of information processing apparatus 110 of occurrence of failure. For example, control device 210 transmits a message indicating occurrence of failure to portable communication terminal 120 registered in advance as a contact destination. Portable communication terminal 120 determines whether or not the user has been given authority to do maintenance for addressing the failure, based on details of failure. This determination is made based on details of authority for maintenance determined for each failure assumed in advance as being likely to occur in information processing apparatus 110. For example, for such failure that a part can easily be replaced, the user is given authority to do maintenance. For such failure that replacement works are defined as being complicated, such as failure requiring disassembly of information processing apparatus 110, the user is not given authority to do maintenance.

In step S1420, when portable communication terminal 120 determines that the user has not been given authority to do maintenance, it shows details of failure and information on a serviceperson on display 35. As the user sees the representation, the user contacts the service center of information processing apparatus 110 to ask the service center to address the failure. The contact may be made by any of a mail and a telephone call. The entity who makes contact is not limited to the user. Based on reception by information processing apparatus 110 or portable communication terminal 120, of a transmission instruction from the user, a message asking the service center to address the failure may be transmitted to portable communication terminal 130 of the serviceperson. As the serviceperson receives such a message, the serviceperson goes to the user's site while carrying parts necessary for maintenance of information processing apparatus 110. When the serviceperson arrives at the user's site, he/she notifies the user of that fact, or operates portable communication terminal 130 to notify portable communication terminal 120 or information processing apparatus 110 of arrival.

In step S1430, when information processing apparatus 110 senses arrival of the serviceperson, it transmits information on a necessary article to portable communication terminal 130 of the serviceperson. In another aspect, information processing apparatus 110 may transmit article information to portable communication terminal 130 based on an instruction from the user. When portable communication terminal 130 receives information from information processing apparatus 110, it shows article information on display 35. Referring to the shown article information, the serviceperson goes to the floor where information processing apparatus 110 is located, while carrying a part (a paper feed roller) and tools necessary for maintenance of information processing apparatus 110.

In step S1440, the serviceperson replaces the paper feed roller and completes maintenance of information processing apparatus 110. Since portable communication terminal 130 shows the procedure on display 35, even the serviceperson less experienced in maintenance of information processing apparatus 110 can reliably do maintenance of information processing apparatus 110 by referring to the procedure. Furthermore, the serviceperson resets a numeric value of a counter that counts a frequency of use of the paper feed roller.

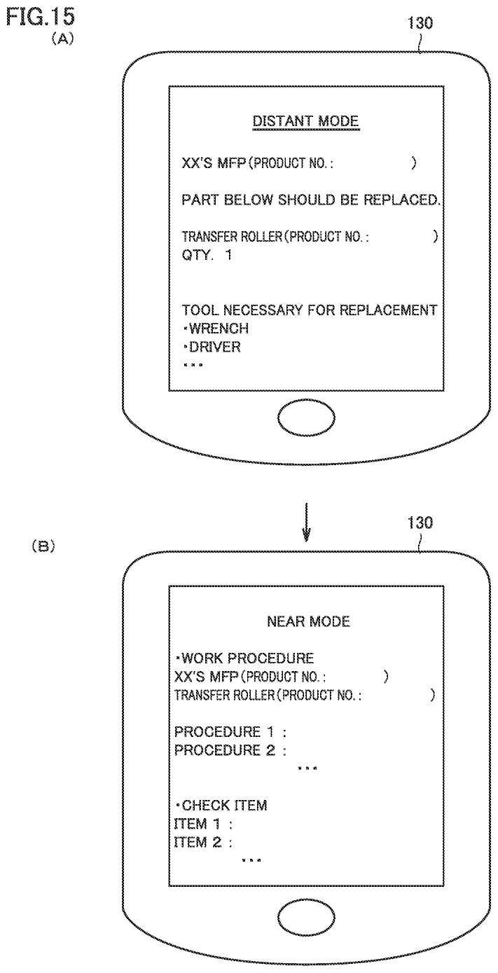

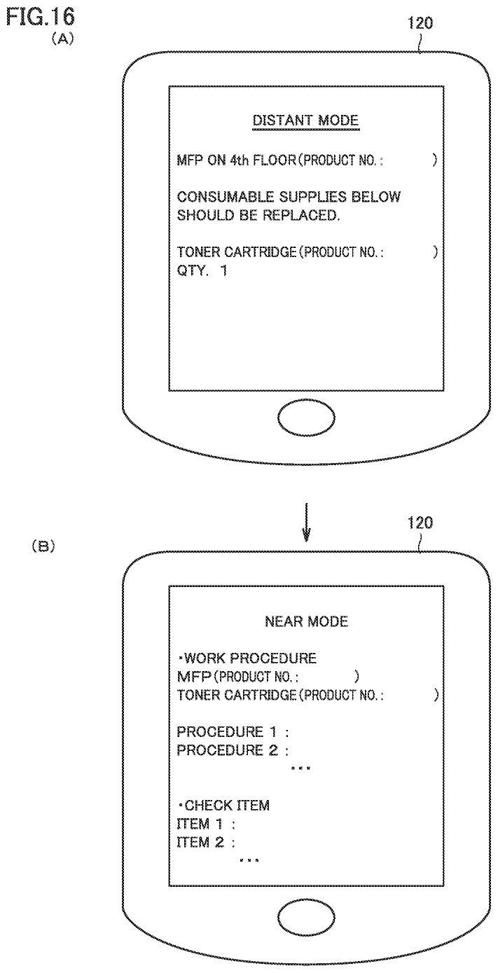

Transition of information shown on display 35 will be described with reference to FIGS. 15 and 16. FIG. 15 is a diagram showing information shown on display 35 of portable communication terminal 130 used by the serviceperson who does maintenance and inspection of information processing apparatus 110. FIG. 16 is a diagram showing information shown on display 35 of portable communication terminal 120 used by the user of information processing apparatus 110.

Referring to FIG. 15, as shown in a state A, when portable communication terminal 130 is distant, display 35 shows a name and a product number of information processing apparatus 110 to be maintained and inspected and identification information for identifying a part necessary for maintenance and inspection. Since the serviceperson can check the information, for example, at the time when he/she brings necessary parts and tools from a vehicle, the serviceperson can be prevented from leaving the parts and the tools behind.

Thereafter, as the serviceperson moves and reaches a position near information processing apparatus 110, as shown in a state B, display 35 shows a specific work procedure for replacing a part and an item to subsequently be checked. Since the serviceperson can thus replace the part by referring to the work procedure, an error can be prevented. The serviceperson can confirm that replacement was done in accordance with a prescribed procedure by checking the check item after replacement.

Referring to FIG. 16, as shown in state A, when portable communication terminal 120 is distant, display 35 shows a location and a name of information processing apparatus 110 to be maintained and inspected and identification information for identifying a consumable article that should be replaced. The user refers to this screen in bringing necessary consumable articles from a controlled stock, so that mix-up can be prevented.

Thereafter, when the user arrives at a position near information processing apparatus 110 while carrying the consumable article with him/her, as shown in state B, display 35 shows a specific work procedure for replacing the article and an item to subsequently be checked. Since the user can replace a part by referring to the work procedure, an error can be prevented. The user can confirm that replacement was done in accordance with a prescribed procedure, by checking the check item after replacement.

<Summary of Embodiment>

As set forth above, when information processing apparatus 110 according to one embodiment senses failure, replacement of a part, or another state requiring maintenance, it determines whether it gives notification to the user of information processing apparatus 110 or to the serviceperson who provides maintenance services for information processing apparatus 110 depending on that state. This determination is made based on notification standards defined in advance for each state of information processing apparatus 110.

When information processing apparatus 110 selects the serviceperson as a notification destination, it transmits a code for identifying a state of information processing apparatus 110 to portable communication terminal 130 used by the serviceperson and transmits a message requesting the serviceperson to do maintenance of information processing apparatus 110.

When the serviceperson arrives at a parking lot of a location (for example, a business establishment or an office) where the user who uses information processing apparatus 110 is located, portable communication terminal 130 shows on display 35, a name of a part or a tool necessary for addressing the state based on the code received from information processing apparatus 110. Therefore, the serviceperson can check again what should be carried.

When the serviceperson enters the user's facility and goes to the floor where information processing apparatus 110 is provided, portable communication terminal 130 shows a work procedure necessary for addressing the present state and a check list of items to be checked after addressing the state. The serviceperson can thus check how to address the state before he/she starts maintenance works. Therefore, a less experienced serviceperson also can properly address the state.

In an example where even the user can address the state sensed by information processing apparatus 110, information processing apparatus 110 has a code for identifying the state and a message requesting the user to address the state shown on portable communication terminal 120 used by the user. When the user is distant from information processing apparatus 110 (for example, the user is present on the floor where information processing apparatus 110 is installed), portable communication terminal 130 gives notification of occurrence of failure, notification of necessity of replacement of consumable supplies, or a notification of a number under which support for information processing apparatus 110 should be provided, based on the identification code received from information processing apparatus 110. When the user is near information processing apparatus 110, for example, when the user arrives at a position close to information processing apparatus 110 in such a vicinity as the user being capable of manually operating information processing apparatus 110, portable communication terminal 120 shows on display 35, a procedure for addressing the state or a procedure for replacing consumable supplies based on the identification code previously received from information processing apparatus 110. The user can address the state by referring to such a procedure.

Since portable communication terminals 120 and 130 can thus show on display 35, information necessary for addressing failure or the like depending on a distance from information processing apparatus 110, it can provide proper information to a serviceperson or a general user.

Technical features disclosed above can be summarized as below.

(1) An information processing apparatus according to one embodiment includes a sensing unit that senses a state of the information processing apparatus, an obtaining unit that obtains a plurality of pieces of information on the state, a distance measurement sensor that measures a distance to a communication terminal that communicates with the information processing apparatus, a memory for storing a plurality of pieces of information defined in advance in accordance with the distance, a selector that selects information from among the plurality of pieces of information based on the distance, and a transmitter that transmits the selected information to the communication terminal.

(2) In the information processing apparatus according to one aspect, selection of the information includes selection of information in accordance with an attribute of a user of the communication terminal.

(3) In the information processing apparatus according to one aspect, the plurality of pieces of information include a first type of information and a second type of information. Selection of the information includes selection of the first type of information when the distance is longer than a predetermined distance and selection of the second type of information when the distance is shorter than the predetermined distance.

(4) In the information processing apparatus according to one aspect, the predetermined distance is different depending on an attribute of a user of the communication terminal.

(5) In the information processing apparatus according to one aspect, the first type of information is information on an article necessary for addressing the state. The second type of information is procedural information on a procedure in maintenance for addressing the state.

(6) In the information processing apparatus according to one aspect, the plurality of pieces of information include information on an article necessary for addressing the state and procedural information on a procedure in maintenance for addressing the state.

(7) In the information processing apparatus according to one aspect, the procedural information includes an item that should be checked after the maintenance is done.

(8) In the information processing apparatus according to one aspect, selection of the information is made based on whether or not a user of the information processing apparatus has authority to address the state.

(9) In the information processing apparatus according to one aspect, the selection of the information includes selection of a plurality of pieces of information for a person who has the authority, based on a fact that the user does not have the authority. The plurality of pieces of information include at least any of information for specifying a tool for replacing an article necessary for maintenance for addressing the state and information for checking an operation after the maintenance.

(10) In the information processing apparatus according to one aspect, selection of the information includes selection of a plurality of pieces of information for a person who has the authority, based on a fact that the user has the authority. The plurality of pieces of information include at least any of identification information for identifying an article necessary for maintenance for addressing the state and information for checking an operation after the maintenance.

(11) In the information processing apparatus according to one aspect, the distance is defined in accordance with whether or not authority to address the state is possessed.

(12) In the information processing apparatus according to one aspect, the distance is defined in accordance with intensity of radio waves emitted to the information processing apparatus.

(13) In the information processing apparatus according to one aspect, the distance is defined in accordance with a type of wireless communication by the information processing apparatus.

(14) A portable communication terminal according to one embodiment includes a receiver that receives information representing a state of an information processing apparatus, a memory for storing a plurality of pieces of information associated with a predefined state of the information processing apparatus, a detector that detects a distance between the information processing apparatus and the portable communication terminal, a selector that selects information defined in advance in accordance with the distance, from among the plurality of pieces of information, and a monitor that shows the selected information.

(15) In the portable communication terminal according to one aspect, the memory holds an attribute of a user of the portable communication terminal Selection of the information includes selection of information in accordance with the attribute of the user.

(16) In the portable communication terminal according to one aspect, the plurality of pieces of information include a first type of information and a second type of information. Selection of the information includes selection of the first type of information when the distance is longer than a predetermined distance and selection of the second type of information when the distance is shorter than the predetermined distance.

(17) In the portable communication terminal according to one aspect, the predetermined distance is different depending on an attribute of a user of the portable communication terminal.

(18) In the portable communication terminal according to one aspect, the first type of information is information on an article necessary for addressing the state. The second type of information is procedural information on a procedure in maintenance for addressing the state.

(19) In the portable communication terminal according to one aspect, the plurality of pieces of information include information on an article necessary for addressing the state and procedural information on a procedure in maintenance for addressing the state.

(20) In the portable communication terminal according to one aspect, the procedural information includes an item that should be checked after the maintenance is done.

(21) In the portable communication terminal according to one aspect, selection of the information is made based on whether or not a user of the information processing apparatus has authority to address the state.

(22) In the portable communication terminal according to one aspect, the selection of the information includes selection of a plurality of pieces of information for a person who has the authority, based on a fact that the user does not have the authority. The plurality of pieces of information include at least any of information for specifying a tool for replacing an article necessary for maintenance for addressing the state and information for checking an operation after the maintenance.

(23) In the portable communication terminal according to one aspect, selection of the information includes selection of a plurality of pieces of information for a person who has the authority, based on a fact that the user has the authority. The plurality of pieces of information include at least any of identification information for identifying an article necessary for maintenance for addressing the state and information for checking an operation after the maintenance.

(24) In the portable communication terminal according to one aspect, the distance is defined in accordance with whether or not authority to address the state is possessed.

(25) In the portable communication terminal according to one aspect, the distance is defined in accordance with intensity of radio waves emitted by the information processing apparatus.

(26) In the portable communication terminal according to one aspect, the distance is defined in accordance with a type of wireless communication by the information processing apparatus.

(27) According to another embodiment, a program for controlling an information processing apparatus is provided. The program causes a computer of the information processing apparatus to perform sensing a state of the information processing apparatus, obtaining a plurality of pieces of information on the state, measuring a distance from a communication terminal that communicates with the information processing apparatus, reading a plurality of pieces of information defined in advance in accordance with the distance, selecting information from among the plurality of pieces of information based on the distance, and transmitting the selected information to the communication terminal.

(28) According to another embodiment, a program for controlling a portable communication terminal is provided. The program causes a computer of the portable communication terminal to perform receiving information representing a state of an information processing apparatus, reading a plurality of pieces of information associated with a predefined state of the information processing apparatus, detecting a distance between the information processing apparatus and the portable communication terminal, selecting information defined in advance in accordance with the distance, from among the plurality of pieces of information, and showing the selected information.

(29) According to another embodiment, a method performed in a computer for controlling an information processing apparatus is provided. This method includes sensing a state of the information processing apparatus, obtaining a plurality of pieces of information on the state, measuring a distance from a communication terminal that communicates with the information processing apparatus, reading a plurality of pieces of information defined in advance in accordance with the distance, selecting information from among the plurality of pieces of information based on the distance, and transmitting the selected information to the communication terminal.

Although embodiments of the present invention have been described and illustrated in detail, the disclosed embodiments are made for the purposes of illustration and example only and not limitation. The scope of the present invention should be interpreted by terms of the appended claims.

What is claimed is:

1. An information processing apparatus comprising:
a processor;
a distance measurement sensor that measures a distance from a communication terminal that communicates with the information processing apparatus; and
a memory for storing a plurality of pieces of information defined in advance in accordance with the distance, wherein
the processor
detects a state of the information processing apparatus,
obtains a plurality of pieces of information on the state,
selects information from among the plurality of pieces of information based on the distance, and
transmits the selected information to the communication terminal.

2. The information processing apparatus according to claim 1, wherein
selection of the information includes selection of information in accordance with an attribute of a user of the communication terminal.

3. The information processing apparatus according to claim 1, wherein
the plurality of pieces of information include a first type of information and a second type of information, and
selection of the information includes selection of the first type of information when the distance is longer than a predetermined distance and selection of the second type of information when the distance is shorter than the predetermined distance.

4. The information processing apparatus according to claim 3, wherein
the predetermined distance is different depending on an attribute of a user of the communication terminal.

5. The information processing apparatus according to claim 3, wherein
the first type of information is information on an article necessary for addressing the state, and
the second type of information is procedural information on a procedure in maintenance for addressing the state.

6. The information processing apparatus according to claim 1, wherein
the plurality of pieces of information include information on an article necessary for addressing the state and procedural information on a procedure in maintenance for addressing the state.

7. The information processing apparatus according to claim 6, wherein
the procedural information includes an item that should be checked after the maintenance is done.

8. The information processing apparatus according to claim 1, wherein
selection of the information is made based on whether a user of the information processing apparatus has authority to address the state.

9. The information processing apparatus according to claim 8, wherein
the selection of the information includes selection of a plurality of pieces of information for a person who has the authority, based on a fact that the user does not have the authority, and
the plurality of pieces of information include at least any of information for specifying a tool for replacing an article necessary for maintenance for addressing the state and information for checking an operation after the maintenance.

10. The information processing apparatus according to claim 8, wherein
selection of the information includes selection of a plurality of pieces of information for a person who has the authority, based on a fact that the user has the authority, and
the plurality of pieces of information include at least any of identification information for identifying an article necessary for maintenance for addressing the state and information for checking an operation after the maintenance.

11. The information processing apparatus according to claim 1, wherein
the distance is defined in accordance with whether authority to address the state is possessed.

12. The information processing apparatus according to claim 1, wherein
the distance is defined in accordance with intensity of radio waves emitted to the information processing apparatus.

13. The information processing apparatus according to claim 1, wherein
the distance is defined in accordance with a type of wireless communication by the information processing apparatus.

14. A portable communication terminal comprising:
a receiver that receives information representing a state of an information processing apparatus;
a memory for storing a plurality of pieces of information associated with a predefined state of the information processing apparatus;
a processor; and
a monitor, wherein
the processor
detects a distance between the information processing apparatus and the portable communication terminal, and
selects information defined in advance in accordance with the distance, from among the plurality of pieces of information, and
the monitor shows the selected information.

15. The portable communication terminal according to claim 14, wherein
the memory holds an attribute of a user of the portable communication terminal, and
selection of the information includes selection of information in accordance with the attribute of the user.

16. The portable communication terminal according to claim 14, wherein
the plurality of pieces of information include a first type of information and a second type of information, and
selection of the information includes selection of the first type of information when the distance is longer than a predetermined distance and selection of the second type of information when the distance is shorter than the predetermined distance.

17. The portable communication terminal according to claim 16, wherein
the predetermined distance is different depending on an attribute of a user of the portable communication terminal.

18. The portable communication terminal according to claim 16, wherein
the first type of information is information on an article necessary for addressing the state, and
the second type of information is procedural information on a procedure in maintenance for addressing the state.

19. The portable communication terminal according to claim 14, wherein
the plurality of pieces of information include information on an article necessary for addressing the state and procedural information on a procedure in maintenance for addressing the state.

20. A non-transitory data recording medium having a program for controlling an information processing apparatus stored thereon, the program causing a computer of the information processing apparatus to perform:
detecting a state of the information processing apparatus;
obtaining a plurality of pieces of information on the state;
measuring a distance from a communication terminal that communicates with the information processing apparatus;
reading a plurality of pieces of information defined in advance in accordance with the distance;
selecting information from among the plurality of pieces of information based on the distance; and
transmitting the selected information to the communication terminal.
